(19) United States
(12) Patent Application Publication
(10) Pub. No.: US 2026/0192700 A1
(43) Pub. Date: Jul. 9, 2026

(54) BATTERY REPLACEMENT DEVICE, BATTERY REPLACEMENT METHOD, AND PROGRAM

(71) Applicant: FOLOFLY INC., Kyoto-shi, Kyoto (JP)

(72) Inventors: Hiroyasu KOMA, Kyoto-shi, Kyoto (JP); Ken ABE, Kyoto-shi, Kyoto (JP); Tatsuhiro YOKOTA, Kyoto-shi, Kyoto (JP); Hiroyuki YAMADA, Kyoto-shi, Kyoto (JP)

(21) Appl. No.: 19/131,758

(22) PCT Filed: Nov. 28, 2023
(86) PCT No.: PCT/JP2023/042528

§ 371 Date: May 21, 2025

(30) Foreign Application Priority Data
Nov. 28, 2022 (JP) 2022-189596

(51) Int. Cl. B60L 53/80; B60S 5/06; G05B 19/042

(52) U.S. Cl. CPC B60L 53/80; B60S 5/06; G05B 19/042; G05B 2219/2637

(57) ABSTRACT

The present invention achieves a battery replacement system for an electric vehicle at a desired place, at low cost, and with simplicity. When an electric vehicle 2 climbs slopes SL in a battery replacement site and stops, a conveyance robot 3 mounts thereon a new battery BN from a battery charging place 4, passes through between the slopes SL, and stops below the body of the electric vehicle 2. The conveyance robot 3 detaches an old battery BO from the electric vehicle 2. The conveyance robot 3 attaches the new battery BO to a lower portion of the body of the electric vehicle 2. The conveyance robot 3 starts a movement with the old battery BO being mounted thereon, and moves to the battery charging place 4.

### CROSS REFERENCE TO RELATED APPLICATIONS

This is the U.S. national stage of application No. PCT/JP2023/042528, filed on Nov. 28, 2023. Priority under 35 U.S.C. § 119 (a) and 35 U.S.C. § 365 (b) is claimed from Japanese Application No. 2022-189596 filed Nov. 28, 2022, the disclosure of which is also incorporated herein by reference.

### TECHNICAL FIELD

The present invention relates to a battery replacement device, a battery replacement method, and a program.

### BACKGROUND ART

In recent years, among electric vehicles, vehicles driven by detachable batteries from the vehicle body have been emerging. For such electric vehicles, a battery replacement location has becomes necessary (for example, refer to Patent Documents 1 to 3).

### CITATION LIST

### Patent Document

Patent Document 1: Japanese Unexamined Patent Application, Publication No.

2012-192782
Patent Document 2: Japanese Unexamined Patent Application, Publication No. 2012-8019
Patent Document 3: Japanese Unexamined Patent Application, Publication No. 2012-6591

### DISCLOSURE OF THE INVENTION

### Problems to be Solved by the Invention

However, conventional battery replacement facilities including the technology described in Patent Documents 1 to 3 are limited to installation sites due to being stationary-type large-scale facilities, and the situation is that, even if there is a location for installation, it is not easy to realize due to high cost.

The present invention has been made in consideration of such circumstances and has an object of realizing a battery replacement system for electric vehicles at a desired location such as a depopulated area simply and at low cost.

### Means for Solving the Problems

A battery replacement system according to one aspect of the present invention is a battery replacement system for replacing a battery mounted in a state locked by a locking part at a lower part of a body of an electric vehicle, the battery replacement system including: a mobile body that conveys the battery as a replacement target; and a control device that executes control of movement of the mobile body, in which the mobile body includes:
a drive unit that drives based on control by the control device;
a detection unit that detects a position of the locking part and transmits the position to the control device;
an arrangement that arranges the battery; and
a lock/release execution part that executes locking to the locking part or releasing thereof based on control by the control device, and in which
the control device includes:
a first movement means that drives the drive unit to cause the mobile body to move below the lower surface of the body of the electric vehicle, on condition of the mobile body becoming mobile below the lower surface of the body of the electric vehicle;
a second movement means that drives the drive unit to cause the mobile body to move to a position of the locking part, based on a detection result of the detection unit;
a battery removal means that causes the locking part to release by way of the lock/release execution part, removes the battery from the electric vehicle, and arranges on the arrangement;
a third movement means that drives the drive unit in a state in which a new battery for replacement is arranged on the arrangement, and causes the mobile body to move to a position of the locking part based on a detection result of the detection unit; and
a battery mounting means that mounts the new battery to a lower part of the body of the electric vehicle, and causes the locking part to lock by way of the lock/release execution part.

Each of a battery replacement method and a program according to an aspect of the present invention is respectively a method and program corresponding to the aforementioned battery replacement system according to an aspect of the present invention.

### Effects of the Invention

According to the present invention, it is possible to realize a battery replacement system for electric vehicles at a desired location such as a depopulated area simply and at low cost.

### BRIEF DESCRIPTION OF THE DRAWINGS

FIG. 1 is an image showing an outline of a battery replacement system according to an embodiment of the present invention;

FIG. 2A and FIG. 2B provide views showing an example of an external configuration of an electric vehicle serving as a target for battery replacement by the battery replacement system in FIG. 1;

FIG. 3 is a perspective view showing an example of the external configuration of a conveyance robot in the battery replacement system of FIG. 1;

FIG. 4 is a view showing a configuration example as an information processing system in the battery replacement system of FIG. 1;

FIG. 5 is a block diagram showing an example of a hardware configuration of a control device in the battery replacement system as the information processing system of FIG. 4;

FIG. 6 is a functional block diagram showing an outline of the functional configuration of the control device of FIG. 5;

FIG. 7 is a flowchart for explaining a flow of battery replacement by the battery replacement system in FIG. 1, executed according to the control of the control device having the functional configuration of FIG. 6;

FIG. 8 is a schematic diagram showing a state prior to an electric vehicle moving to a slope, the diagram specifically illustrating Step S11 of the flowchart in FIG. 7;

FIG. 9 is a schematic diagram showing a state after an electric vehicle moved to a slope, the diagram specifically illustrating the Step S11 of the flowchart in FIG. 7;

FIG. 10 is a schematic diagram showing an aspect of a conveyance robot moving from between slopes to a lower surface of a body of an electric vehicle, the diagram specifically illustrating Step S12 of the flowchart in FIG. 7;

FIG. 11 is a schematic diagram showing an aspect of the conveyance robot removing the battery from the electric vehicle, the diagram specifically illustrating Steps S13 and S14 of the flowchart in FIG. 7;

FIG. 12 is schematic diagram showing an aspect of the conveyance robot mounting the battery to the electric vehicle, the diagram specifically illustrating Steps S15 and S16 of the flowchart in FIG. 7;

FIG. 13 is a schematic diagram showing an image of the conveyance robot mounting the battery to the electric vehicle in the case of adopting a screw mechanism as a locking mechanism;

FIG. 14 is a view showing an example of an external configuration of a conveyance robot in the case of adopting the screw mechanism of FIG. 13 as a locking mechanism, i.e. example different from FIG. 3;

FIG. 15A and FIG. 15B are schematic diagrams showing an image in the case of adopting a mechanism establishing a locked state with a striker and a catch as the locking mechanism;

FIG. 16 is a view showing an example of a configuration of a battery module of an electric vehicle serving as a target of battery replacement by the battery replacement system;

FIG. 17 is a perspective view showing an example of an external configuration of the conveyance robot applied to the electric vehicle of FIG. 16 in the battery replacement system;

FIG. 18 is a perspective view showing an example of a battery frame constituting the battery module in FIG. 16;

FIG. 19 is a perspective view showing an example of a battery main body constituting the battery module in FIG. 16;

FIG. 20 is a perspective view showing an example of an aspect of removing the battery main body from the battery frame in FIG. 16;

FIG. 21 is a perspective view showing an example of an aspect of mounting the battery main body to the battery frame in FIG. 16; and

FIG. 22 is a cross-sectional view showing an example of an aspect immediately before finishing mounting of a battery main body to the battery frame in FIG. 16.

### PREFERRED MODE FOR CARRYING OUT THE INVENTION

Hereinafter, an embodiment of the present invention will be described using the drawings.

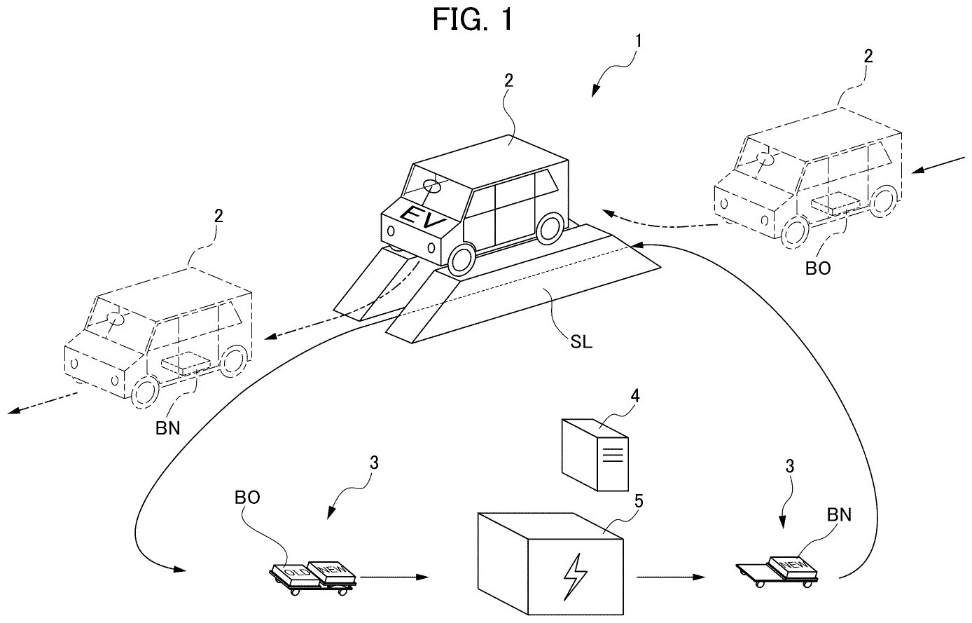

FIG. 1 is an image showing an outline of a battery replacement system according to an embodiment of the present invention.

A battery replacement system 1 according to an embodiment of the present invention is a system for replacing an old battery BO mounted to a lower part of a body of an electric vehicle 2 with a new battery BN, using a mobile conveyance robot 3. The conveyance robot 3 is a self-propelled robot that drives based on the control of a control device 4.

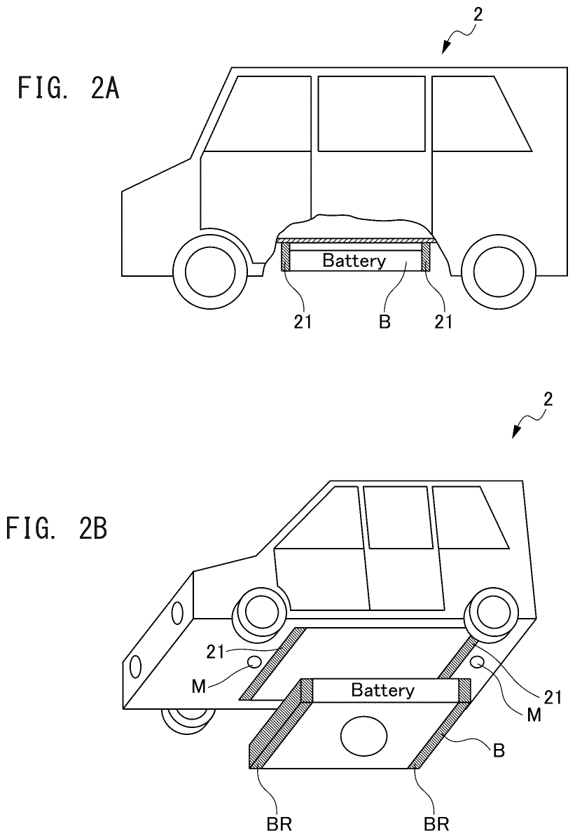

More specifically, for example, as shown in FIG. 1, first, the electric vehicle 2 climbs up and stops on slopes SL functioning as a battery replacement location. When this is done, the conveyance robot 3 loads a new battery BN which is fully charged at the battery charging location 4 and starts movement and moves from between the slopes SL to below the body of the electric vehicle 2. At this stage, the old battery BO is a state locked by a locking part (locking part 21 in FIG. 2A and FIG. 2B described later) of the electric vehicle 2, i.e. state mounted to the electric vehicle 2. Therefore, the conveyance robot 3 removes the old battery BO from the electric vehicle 2 by releasing the locked state of the locking part. Next, the conveyance robot 3 mounts this new battery BO to the electric vehicle 2, by causing the new battery BO to move to a lower part of the body of the electric vehicle 2, and locking by the locking part. Then, the conveyance robot 3 starts movement in a state loaded with the old battery BO and moves until the battery charging location 4. The old battery BO thereby starts charging and comes to function as a new battery BN after full charging.

By configuring in this way, since it is sufficient if preparing only the conveyance robot 3 and control device 4, it becomes possible to inexpensively and easily configure the battery replacement system. In addition, as long as there are the slopes SL and the battery charging location 4, since a large scale facility such as that conventionally is unnecessary, it becomes possible to realize a battery replacement system at a desired location such as a depopulated area, for example.

FIG. 2A and FIG. 2B views showing an example of an external configuration of an electric vehicle serving as the target of battery replacement by the battery replacement system in FIG. 1. FIG. 2A is a view which is an outline of a lateral side of an electric vehicle, showing a state in which the battery is mounted. FIG. 2B is a view which is an outline of a lower surface of the electric vehicle, showing a state in which the battery is removed. As shown in FIG. 2A, the electric vehicle 2 has the locking part 21 at a lower part of the body, mounts a battery B by locking with this locking part 21, and drives using the electric power supplied from this battery B. As shown in FIG. 2B, the battery B is configured so as to be removed from the electric vehicle 2, when the lock is released by the locking part 21.

Herein, although the mechanism for locking of the locking part 21 is not particularly limited, for convenience of explanation in the present embodiment, it shall have a mechanism which locks the battery B by magnetism. More specifically, for example, the locking part 21 shall have a permanent magnet of predetermined polarity (for example, N pole) on a mounting surface of the battery B. In addition, a contacting part BR of the battery B which contacts with the locking part 21 shall have a permanent magnet for which the magnetism is reversed by the conveyance robot 3 described later. The contacting part BR of the battery B is thereby locked by the locking part 21 as shown in FIG. 2A, and mounted to the electric vehicle 2, by establishing the polarity of this permanent magnet as the reverse polarity (for example, S pole) to the predetermined polarity of the locking part 21. On the other hand, the contacting part BR of the battery B is mounted to the electric vehicle 2 by establishing the polarity of the permanent magnet thereof as the same polarity (for example, N pole) as the predetermined polarity of the locking part 21, whereby the locking by the locking part 21 is released as in FIG. 2B.

In addition, for the conveyance robot 3 to recognize the position of the locking part 21, markers M such as those shown in FIG. 2B are provided to this locking part 21 itself or the vicinity thereof.

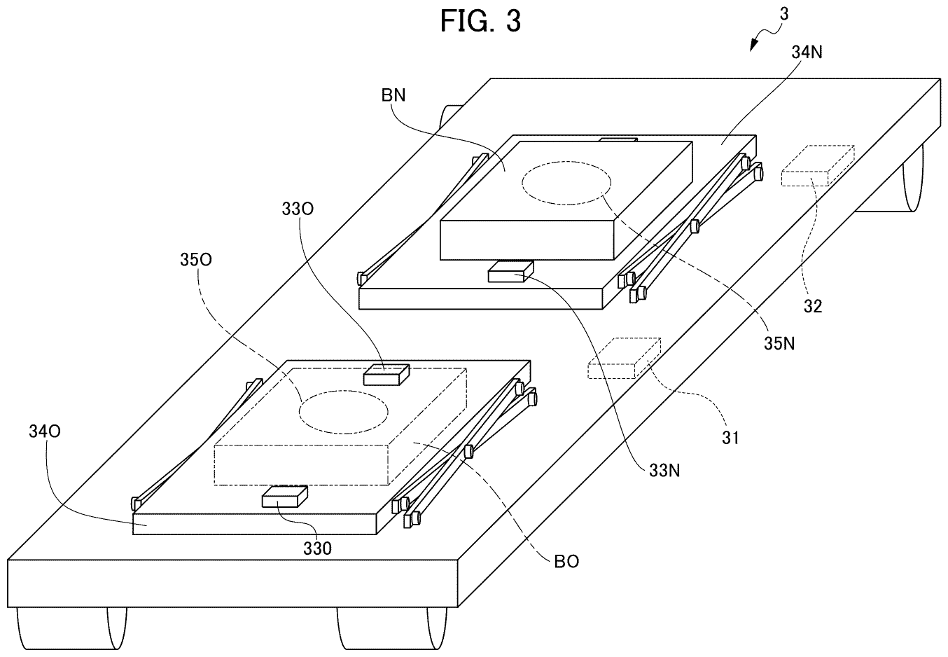

FIG. 3 is a perspective view showing an example of the external configuration of the conveyance robot of the battery replacement system in FIG. 1. The conveyance robot 3 includes a controller 31, a drive unit 32, servo units 33O, 33N, arrangements 34O, 34N, and lock/release execution parts 35O, 35N. Herein, as shown in FIG. 3, the conveyance robot 3 of the present embodiment has a function of conveying the old battery BO which is the removal target, and conveying the new battery BN, which is the mounting target. For this reason, “O” is attached to the end of the reference numbers at parts targeting the old battery BO, and “N” is attached to the end of the reference numbers of parts targeting the new battery BN. However, in the case of not requiring to distinguish between the old battery BO and the new battery BN (case simply stating “battery B”), it shall be described without attaching this “N” or “O” to the reference number. The controller 31 makes communication with the control device 4 and controls the overall operation of the conveyance robot 31. The drive unit 32 exerts a driving force based on the control of the controller 31 and executes a movement operation of the conveyance robot 3, a lifting operation of the arrangement 34, and operations of lock or release of the lock/release execution part 35. The sensor unit 33 detects the position of the locking part 21 (FIG. 2A and FIG. 2B) of the electric vehicle 2, and sends the position to the controller 31. In the present embodiment, as shown in FIG. 2B, since the markers M are provided to the locking part 21 or the vicinity thereof, the sensor unit 33 is configured as an optical sensor, for example, and detects the position of the locking part 21 of the electric vehicle 2 by recognizing the marker M, and sends this to the controller 31. The arrangement 34 arranges the battery B, and executes the lifting operation during detachment of the battery B to the electric vehicle 2, based on the control of the controller 31. The lock/release execution part 35 executes locking to the locking part 21 or release thereof, based on the control of the controller 31. More specifically, in the present embodiment, for example, the lock/release execution part 35, in the case of executing locking to the locking part 21, causes the polarity of the permanent magnet of the contacting part BR of the battery B to reverse to the reverse polarity (for example, S pole) from the predetermined polarity of the locking part 21. On the other hand, in the case of executing the release of locking to the locking part 21, the lock/release execution part 35 causes the polarity of the permanent magnet of the contacting part BR of the battery B to reverse to the same polarity (for example, N pole) as the predetermined polarity of the locking part 21.

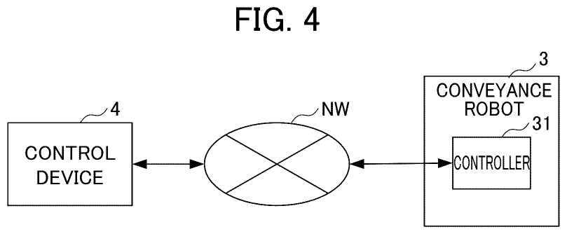

FIG. 4 is a view showing a configuration example as an information processing system of the battery replacement system in FIG. 1.

The battery replacement system shown in FIG. 4 is configured by the controller 31 of the conveyance robot 3 and the control device 4 being connected to each other via a predetermined network NW. Herein, the predetermined network NW, for example, adopts a wireless network established using Wi-Fi (registered trademark) in the present embodiment; however, it is not particularly limited, and in the case of the control device 3 being in the proximity of the conveyance robot 3, a wireless network established using Bluetooth (registered trademark) may be adopted, and in the case of the control device 3 being present in a remote location, the Internet may be adopted.

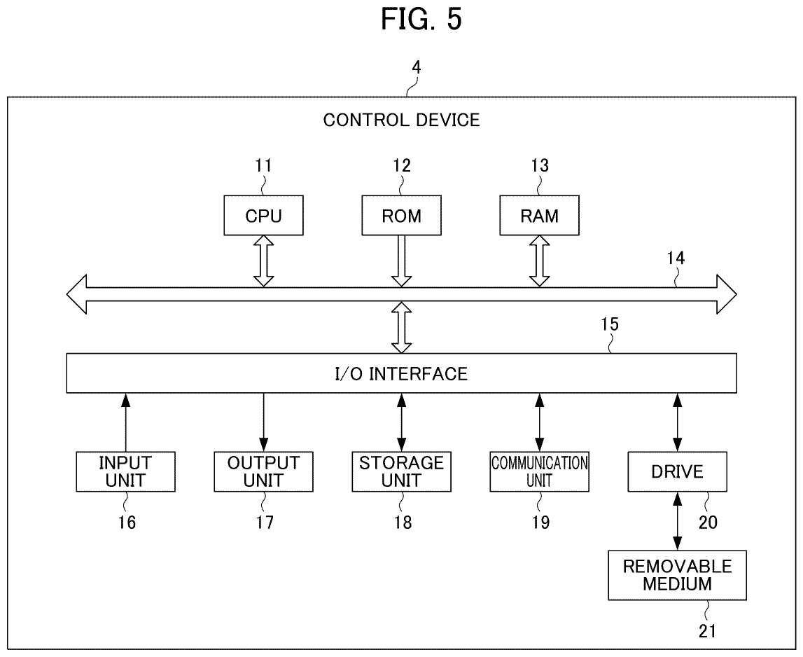

FIG. 5 is a block diagram showing an example of a hardware configuration of a control device in the battery replacement system as an information processing system of FIG. 4.

The control device 4 includes a CPU (Central Processing Unit) 11, ROM (Read Only Memory) 12, RAM (Random Access Memory) 13, a bus 14, an I/O interface 15, an input unit 16, an output unit 17, a storage unit 18, a communication unit 19, and a drive 20.

The CPU 11 executes various processing in accordance with a program recorded into the ROM 12, or a program loaded from the storage unit 18 into the RAM 13. The data, etc. required upon the CPU 11 executing the various processing is also stored as appropriate in the RAM 13.

The CPU 11, the ROM 12 and the RAM 13 are connected to each other via the bus 14. The I/O interface 15 is also connected to this bus 14. The input unit 16, the output unit 17, the storage unit 18, the communication unit 19 and the drive 20 are connected to the I/O interface 15.

The input unit 16 is configured by various hardware, etc., and inputs various information. The output unit 17 is configured by various liquid crystal displays, etc., and outputs various information. The storage unit 18 is configured by DRAM (Dynamic Random Access Memory), etc., and stores various data. The communication unit 19 controls communication performed with other devices via a network including the Internet.

The drive 20 is provided as necessary. A removable medium 21 consisting of a magnetic disc, an optical disc, a magneto-optical disc or semiconductor memory is fitted as appropriate to the drive 20. A program read from the removable medium 21 by the drive 20 is installed to the storage unit 18 as necessary. In addition, the removable medium 21 can store various data stored in the storage unit 18 similarly to the storage unit 18.

It should be noted that, although not illustrated, the controller 31 of the conveyance robot 3 also has the hardware configuration shown in FIG. 5, in which the drive unit 32, the sensor unit 33, the arrangement 34 and the lock/release execution part 35 are connected to the I/O interface 15.

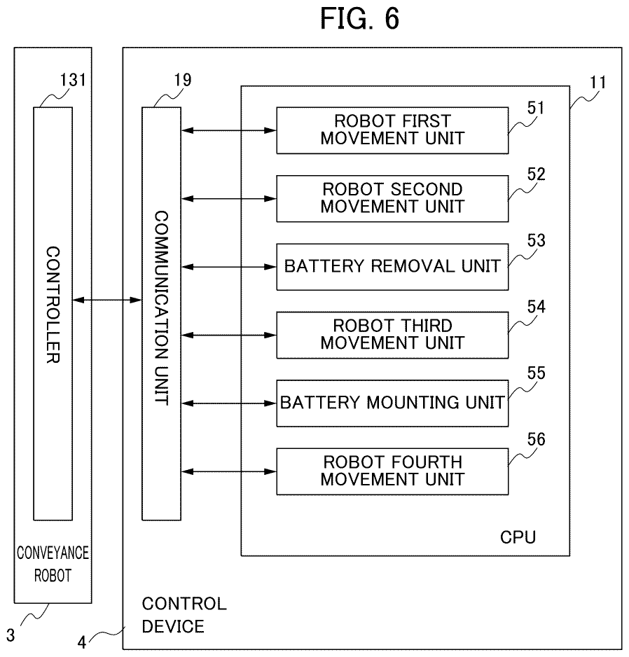

FIG. 6 is a functional block diagram showing an outline of the functional configuration of the control device in FIG. 5.

As shown in FIG. 6, a robot first movement unit 51, a robot second movement unit 52, a battery removal unit 53, a robot third movement unit 54, a battery mounting unit 55, and a robot fourth movement unit 56 function in the CPU 11 of the control device 4.

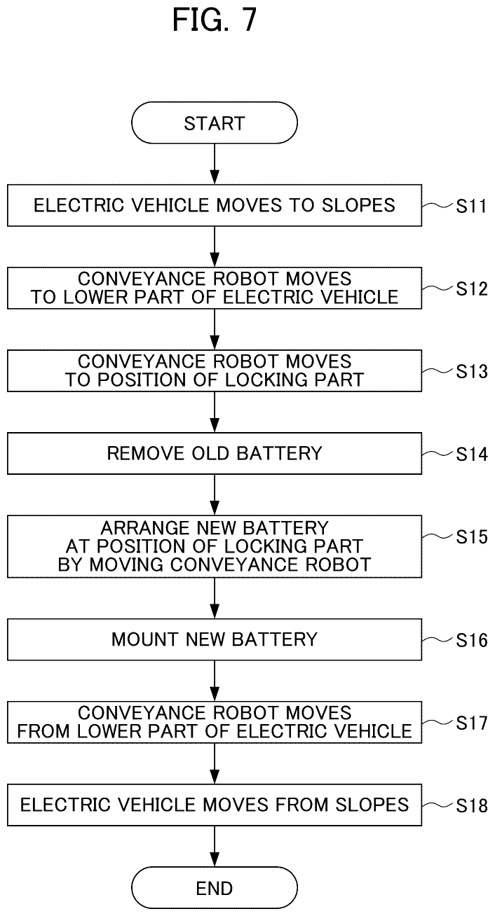

The function of each functional block shown in FIG. 6 of the control device 4 will be described while referencing the flowchart in FIG. 7. FIG. 7 is a flowchart illustrating the flow of battery replacement by the battery replacement system of FIG. 1, executed according to the control of the control device having the functional configuration of FIG. 6.

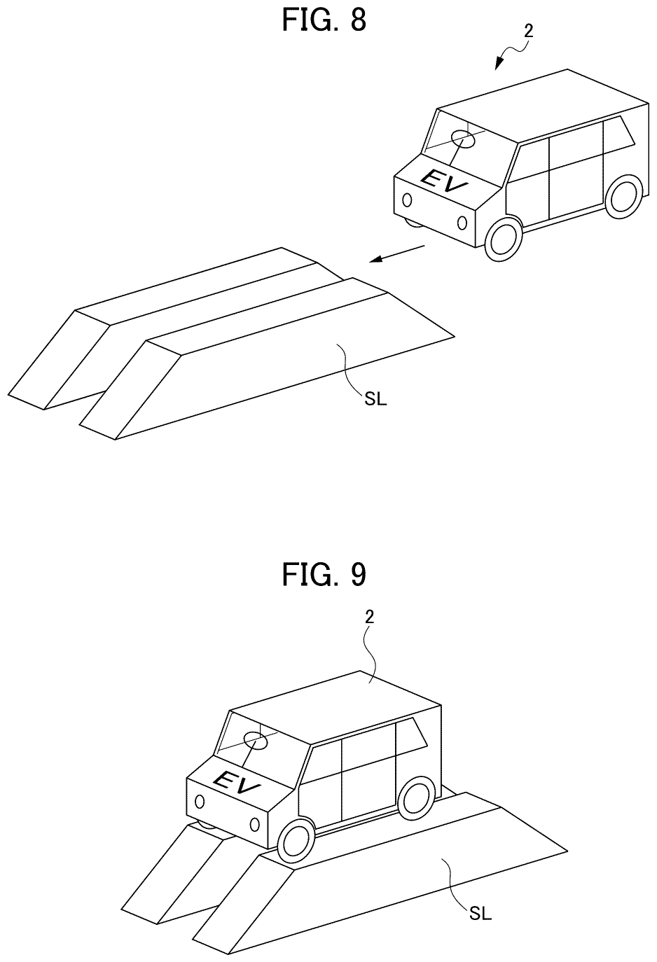

In Step S11, the electric vehicle 2 moves to the slopes SL. More specifically, the electric vehicle 2 moves from the state shown in FIG. 8 to the state shown in FIG. 9 and stops. FIG. 8 is a schematic diagram showing a state prior to the electric vehicle moving to the slopes, the diagram specifically illustrating Step S11 of the flowchart in FIG. 7 FIG. 9 is a schematic diagram showing a state after the electric vehicle moves to the slopes, the diagram specifically illustrating Step S11 of the flowchart in FIG. 7.

It should be noted that, although not illustrated, a sensor detecting that the electric vehicle 2 is placed on (moved to) a certain position is arranged at the slope SL, and the detection result from this sensor is transmitted to the control device 4. When the control device 4 receives the detection result from this sensor, i.e. when detected that the electric vehicle 2 is placed on (moved to) the certain position on the slope SL, it recognizes that the conveying robot 3 is movable below the lower surface of the body of the electric vehicle 2 and advances the processing from Step S11 to Step S12. In this way, as long as there are the slopes SL, the conveyance robot 3 can freely move below the lower surface of the body of the electric vehicle 2. In other words, so long as being a location at which slopes SL can be installed, no matter where, it is possible to adopt the battery replacement system, even without being a location having a conventional large-scale stationary-type facility.

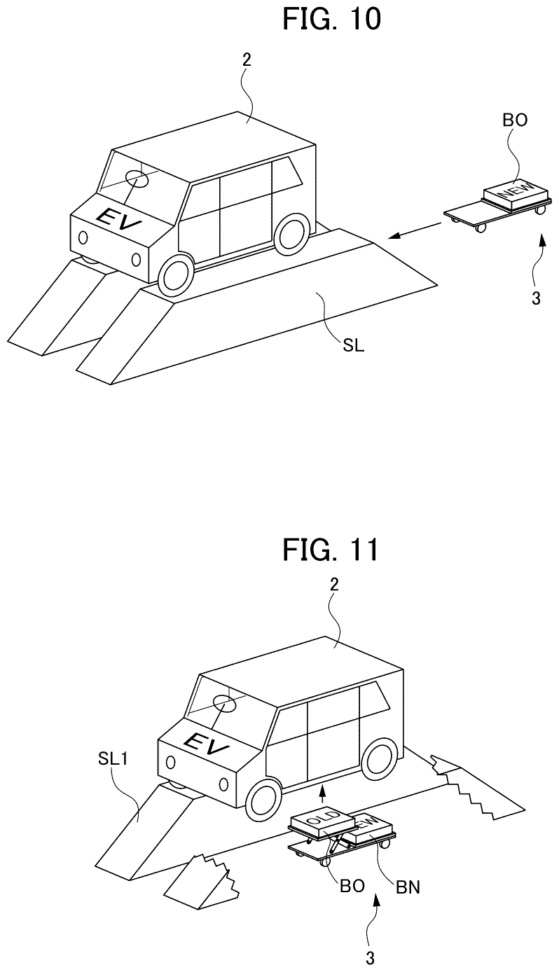

In Step S12, the robot first movement unit 51 of the control device 4 drives the drive unit 32 via the controller 31 of the conveyance robot 3 to cause the conveyance robot 3 to move below the lower surface of the body of the electric vehicle 2. In other words, the conveyance robot 3 loads the new battery BN in the battery charging location 5 in FIG. 1 and moves from between the slopes SL to the lower surface of the body of the electric vehicle 2, as shown in FIG. 10. FIG. 10 is a schematic diagram showing an aspect of the conveyance robot moving from between the slopes to the lower surface of the body of the electric vehicle, the diagram specifically illustrating Step S12 of the flowchart in FIG. 7.

In Step S13, the robot second movement unit 52 of the control device 4 drives the drive unit 32 based on the detection results of the sensor unit 33 via the controller 31 of the conveyance robot 3 to cause the conveyance robot 3 to move to the position of the locking part 21 on the lower surface of the body of the electric vehicle 2. In Step S14, the battery removal unit 53 of the control device 4 causes the locking part 21 to release by way of the lock/release execution part 35 via the controller 31 of the conveyance robot 3 and removes the old battery BO from the electric vehicle 2 to be arrange on the arrangement 34O.

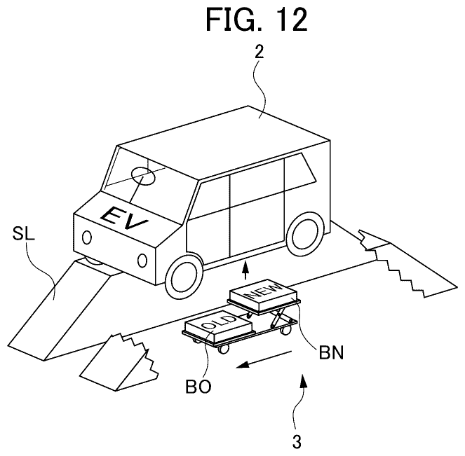

Steps S13 and S14 will be specifically described by referencing FIG. 11. FIG. 11 is a schematic diagram showing an aspect of the conveyance robot removing the battery from the electric vehicle, the diagram specifically illustrating Steps S13 and S14 of the flowchart in FIG. 7.

For example, in Step S13, the conveyance robot 3 moves to the position shown in FIG. 11. It should be noted that, at the stage of Step S13, due to being prior to removal of the old battery BO, the old battery BO is not arranged on the conveying device 3 as in FIG. 11, and although not illustrated, it is a state in which the old battery BO is mounted to the electric vehicle 2. More specifically, the conveyance robot 3 of the present embodiment includes the arrangement 34O on which the old battery BO is arranged, and the arrangement 34N on which the new battery BN is arranged, as shown in FIG. 3. Since the movement in Step S13 is movement for removing the old battery BO, the sensor unit 33O adjacent to the arrangement 34O will move until recognizing the marker M (refer to FIG. 2B) of the electric vehicle 2 and detecting the position of the locking part 21. In other words, as shown in FIG. 11, the conveyance robot 3 moves so that the arrangement 34O approaches a position at which the old battery BO is mounted.

In Step S14, the arrangement 34O of the conveyance robot 3 rises to bring the lock/release execution part 35O into contact with the old battery BO, and this lock/release execution part 350 reverses the polarity of the permanent magnet of the contact part BR of the old battery BO to the same polarity (for example, N pole) as the predetermined polarity of the locking part 21, thereby releasing the locked state of the locking part 21. Then, when the arrangement 34O descends, the old battery BO comes to be removed from the electric vehicle 2, as shown in FIG. 11.

Next, in Step S15, the robot third movement unit 54 of the control device 4 drives the drive unit 32 based on the detection results of the sensor unit 33 via the controller 31 of the conveyance robot 3 to cause the conveyance robot 3 to move, thereby arranging the new battery BN at the position of the locking part 21 on the lower surface of the body of the electric vehicle 2. In Step S16, the battery mounting unit 55 of the control device 4 mounts the new battery BN to the lower part of the body of the electric vehicle 2 and causes to lock with the locking part 21 by the lock/release execution part 35, via the controller 31 of the conveyance robot 3.

Steps S15 and S16 will be specifically described by referencing FIG. 12. FIG. 12 is a schematic diagram showing an aspect of the conveyance robot mounting the battery to the electric vehicle, the diagram specifically illustrating Steps S15 and S16 of the flowchart in FIG. 7.

For example, in Step S15, the conveyance robot 3 moves to the position shown in FIG. 12. More specifically, the conveyance robot 3 of the present embodiment includes the arrangement 34O on which the old battery BO is arranged, and the arrangement 34N on which the new battery BN is arranged, as shown in FIG. 3. Due to the movement of Step S15 being movement for mounting the new battery BN, the sensor unit 33N adjacent to the arrangement 34N moves until recognizing the marker M (refer to FIG. 2B) of the electric vehicle 2 and detecting the position of the locking part 21. In other words, as shown in FIG. 12, the conveyance robot 3 moves so that the arrangement 34N approaches the mounting position (lower position of locking part 21) of the new battery BN.

In Step S16, the arrangement 34N of the conveyance robot 3 rises to cause the new battery BN to mount to the lower part of the body of the electric vehicle 2, and subsequently the lock/release execution part 35L reverses the polarity of the permanent magnet of the contacting part BR of the new battery BN to the opposite polarity (for example, S pole) to the predetermined polarity of the locking part 21, thereby locking with the locking part 21.

Subsequently, when the arrangement 34N descends, the robot fourth movement unit 56 of the control device 4 drives the drive unit 32 via the controller 31 of the conveyance robot 3 to cause the conveyance robot 3 to move off the slopes SL. The processing thereby advances from Step S17 to Step S18. In Step S18, the electric vehicle 2 moves from the slopes SL. The battery replacement of the electric vehicle 2 thereby comes to an end.

Although an embodiment of the present invention has been described above, the present invention is not to be limited to the aforementioned embodiment, and modifications, improvements, etc. within a scope that can achieve the object of the present invention are also included in the present invention.

For example, a mechanism whereby the locking part 21 of the electric vehicle 2 locks the battery B (hereinafter called “locking mechanism”) can adopt various types of mechanisms, and although a mechanism using magnetic force is adopted in the aforementioned embodiment, is not particularly limited thereto.

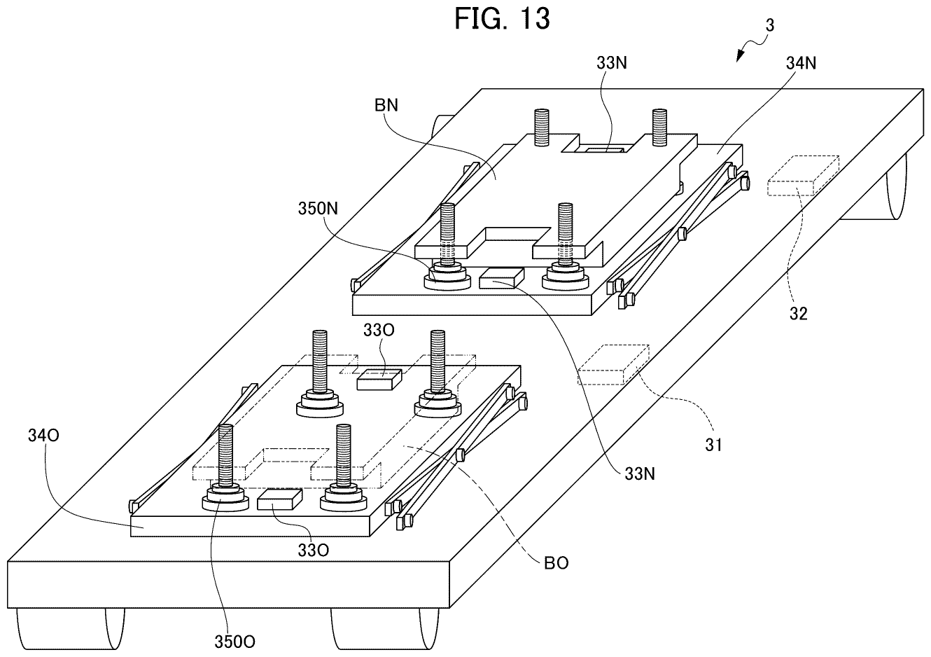

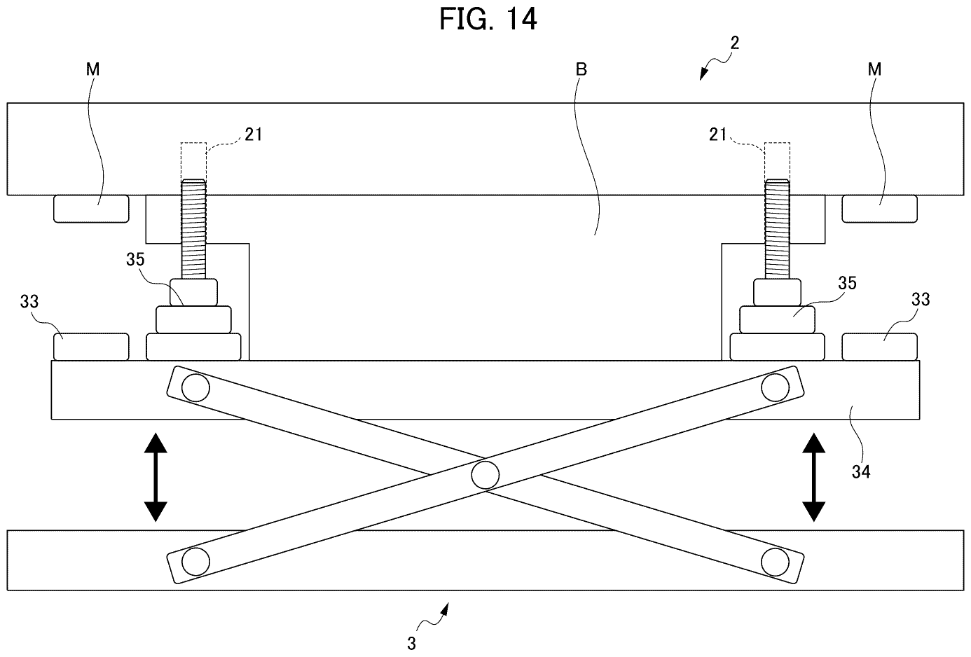

More specifically, as shown in FIG. 13, for example, a mechanism which attaches and detaches the battery B by screws (hereinafter called “screw-type mechanism”) may be adopted as the locking mechanism. FIG. 13 is a schematic diagram showing an image of the conveyance robot mounting the battery to the electric vehicle in the case of adopting a screw-type mechanism as the locking mechanism. FIG. 14 is a view showing an example of the external configuration of the conveyance robot in the case of adopting the screw-type mechanism of FIG. 13 as the locking mechanism, i.e. example different from FIG. 3. In FIGS. 13 and 14, configurations which are similar to FIG. 3 are indicated by the same reference symbols, and descriptions thereof will be omitted. In addition, since FIG. 13 depicts the new battery BN and the old battery BO without distinguishing therebetween as battery B, neither “O” nor “N” is attached as a reference symbol. The conveyance robot 3 of the example in FIG. 14, compared to the conveyance robot 3 of the example in FIG. 3, includes the same configurations for the controller 31, drive unit 32, sensor units 33O, 33N and arrangements 34O, 34N; however, due to the locking mechanism differing, it includes lock/release execution parts 350O, 350N which are different from the example in FIG. 3. In other words, as shown in FIG. 13, the locking part 21 of the screw-type mechanism is configured as a screw hole into which a screw is threaded. For this reason, the lock/release execution part 350 is configured as a manipulator having a driver function (function of installing a screw and rotating to thread or unthread to remove). In this case, as shown in FIG. 13, when the battery B is mounted to the electric vehicle 2, the lock/release execution part 350 inserts the screw into a screw hole (locking part 21) and causes to rotate in a predetermined direction, thereby threading the screw into the screw hole (locking part 21). The locking part 21 thereby enters the locked state. On the other hand, when the battery B is removed from the electric vehicle 2, the lock/release execution part 350 causes the screw to rotate in the opposite direction from the aforementioned predetermined direction, thereby unthreading and removing the screw from the screw hole (locking part 21). The locked state of the locking part 21 is thereby released.

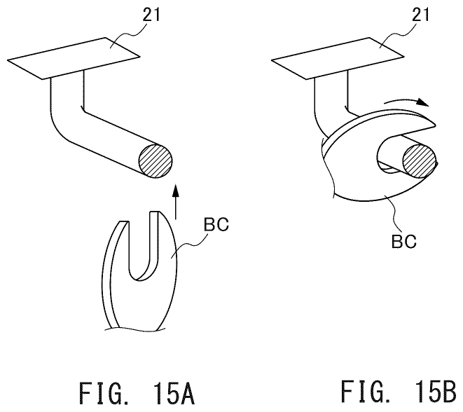

In addition, as shown in FIG. 15A and FIG. 15B, for example, a mechanism establishing a locked state by the striker and catch similarly to the door of a passenger car may be adopted as the locking mechanism. FIG. 15A and FIG. 15B are schematic diagrams showing an image of a case of adopting a mechanism establishing the locked state with a striker and a catch as the locking mechanism. As shown in FIG. 15A and FIG. 15B, the locking part 21 is configured as the striker, and a catch BC is provided to the battery B. When the battery B is mounted to the electric vehicle 2, the lock/release execution part (reference symbol not noted due to not being illustrated) of the conveyance robot 3 inserts the catch BC into the striker (locking part 21) as shown in FIG. 15A, and causes the catch BC to rotate as shown in FIG. 15B. The locking part 21 thereby enters the locked state. On the other hand, when the battery B is removed from the electric vehicle 2, the lock/release execution part 350 enters the state of FIG. 15A from the state of FIG. 15B. The locked state of the locking part 21 is thereby released.

In addition, although two of the markers M for detecting the position of the locking part 21 in the conveyance robot 3 (sensor unit 33) are provided in the aforementioned embodiment, it is not particularly limited thereto. For example, in the case of the size of battery B not necessarily being standardized, and having variation according to the type of electric vehicle 2, it is necessary for the control device 4 to make control for replacement of this battery B after ascertaining the size of the battery B. In such a case, each of a plurality of markers M may be provided to positions from which the size of the battery B can be recognized (any positions below the body of the electric vehicle 2). In this case, although not illustrated, the control device 4 comes to further include a battery size recognition unit that recognizes the size of the battery B based on the detection results of the sensor unit 33 of the conveyance robot 3.

In addition, although the number of conveyance robots 3 is set to one in the aforementioned embodiment, for example, it is not particularly limited thereto, and may be a plurality of robots. For example, the conveyance robot 3 may be configured with a total of two robots: one for removal of the old battery BO, and one for mounting of the new battery BN. In this case, among the functional configurations in FIG. 6, the control device 4 can set the first one as the control target for the robot first movement unit 51, the robot second movement unit 53 and the battery removal unit 54, set the second one as the control target for the robot third movement unit 54 and the battery mounting unit 55, and set the first one and second one as the control targets for the robot fourth movement unit 56.

For example, the control device 4 is provided outside of the conveyance robot 3 in the aforementioned embodiment; however, it may be built into the conveyance robot 3. In the case of being built-in, the control device 4 and the controller 31 may be provided separately; however, they may be integrated into one.

In addition, for example, for the removal of the old battery BO and mounting of the new battery BN, although attachment/detachment is carried out with the movement in the up/down direction (height direction) of the electric vehicle 2, it may be configured so that attachment/detachment is performed by causing sliding movement (slide operation) in the left/right direction (width direction) along the lower surface of the electric vehicle 2, or in the front/rear direction (overall length direction) along the lower surface (having an advantage of being able to give variation to the battery attachment/detachment).

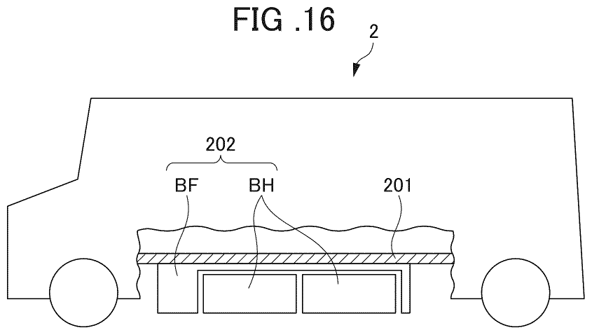

Hereinafter, attachment/detachment of the battery performed in the above-mentioned sliding movement will be described by referencing FIG. 16 to FIG. 22. It should be noted that the reference symbols indicating new and old relative to the batteries shall be omitted. FIG. 16 is a view showing an example of the configuration of a battery module of an electric vehicle serving as the target for battery replacement by the battery replacement system.

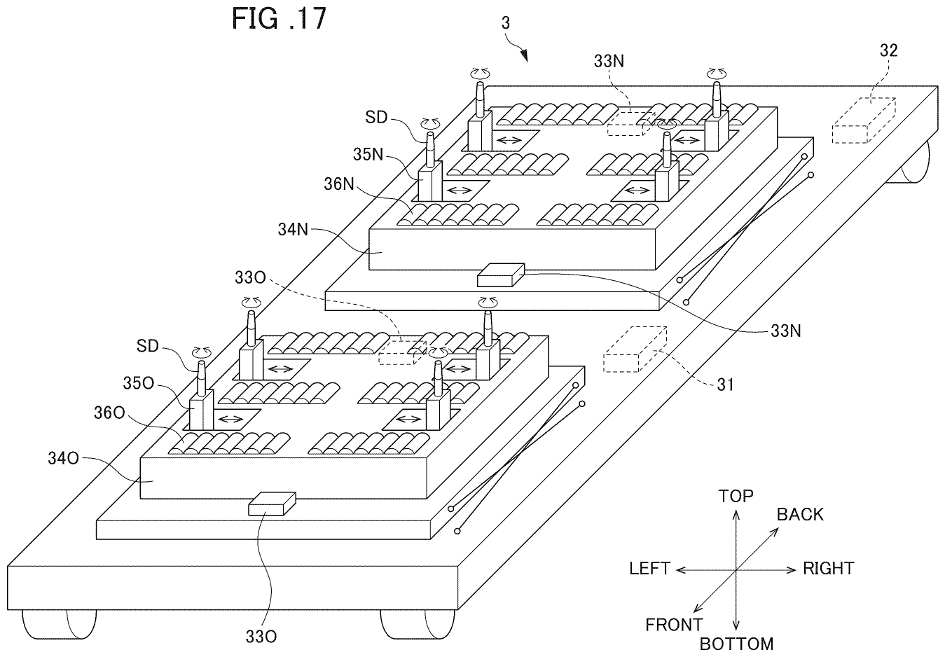

The battery module 202 is installed to the lower part 201 of the body of the electric vehicle 2. This battery module 202 is configured to include a battery frame BF, and a plurality of battery main bodies BH. The plurality of battery main bodies BH becomes detachable relative to the battery frame BF by the conveyance robot 3 shown in FIG. 17.

It should be noted that, although the number is not particularly limited, a configuration is described with four of the battery main bodies BH. In addition, in the present embodiment, a conveyance robot 3 having a structure suited for attachment/detachment of an even number of battery main bodies BH shall be used.

First, the conveyance robot 3 will be described referencing FIG. 17. FIG. 17 is a perspective view showing an example of an external configuration of the conveyance robot applied to the electric vehicle in FIG. 16 among the battery replacement system.

The conveyance robot 3 includes the controller 31, the drive unit 32, the sensor unit 33O and sensor unit 33N, the arrangement 34O and arrangement 34N, the lock/release execution part 35O and lock/release execution part 35N, and the roller 36O and roller 36N. It should be noted that, herein, “O” is attached to the end of the reference symbol to parts targeting the old battery, and “N” is attached to the end of the reference symbol to parts targeting the new battery. However, in the case of not needing to distinguish between the old battery and the new battery, it shall be described without attaching this “N” and “O” to the reference symbol.

The conveyance robot 3 of the present embodiment in FIG. 17 has a function of conveying the old battery (battery main body BH) which is the removal target and conveying the new battery (battery main body BH) which is the mounting target, similarly to the aforementioned conveyance robot 3 (described referencing FIG. 3).

The controller 31 makes communication with the control device 4 to control the overall operations of the conveyance robot 31. The drive unit 32 exerts the driving force based on the control of the controller 31 to cause the movement operation of the conveyance robot 3, slide operation of the battery main body BH on the arrangement 34, and operation of lock or release of the lock/release execution part 35 to be executed.

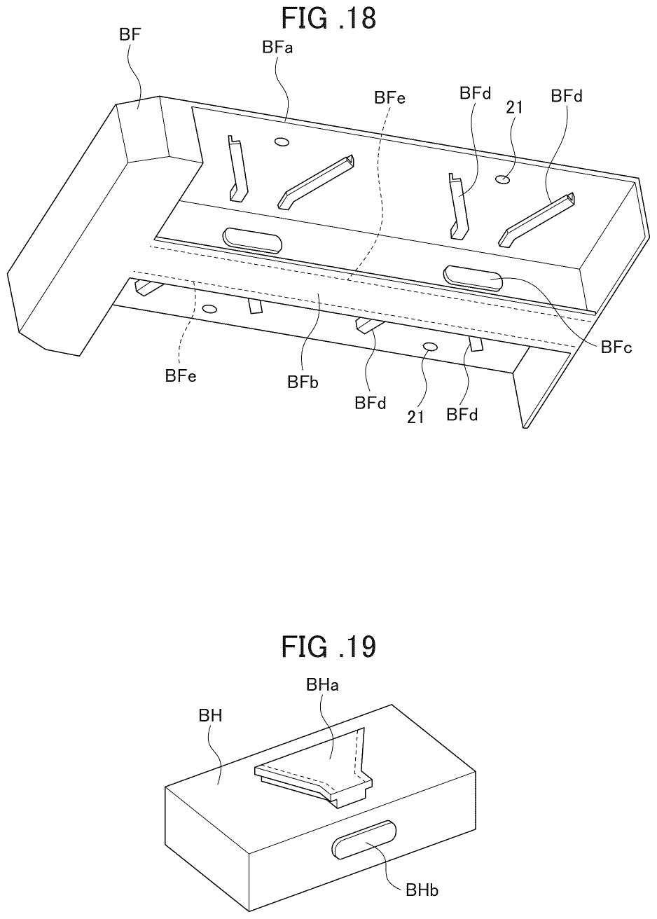

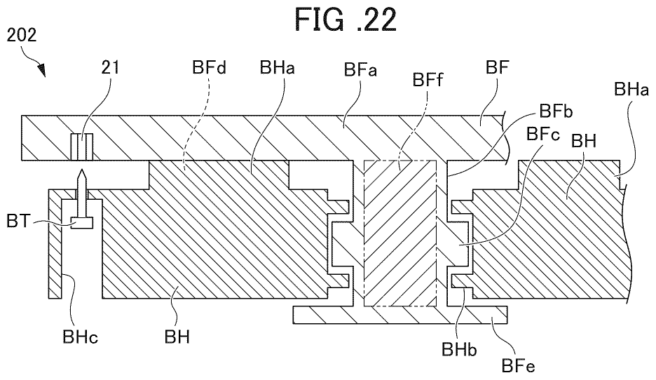

The sensor unit 33 detects the position of the locking part 21 of the electric vehicle 2 (refer to FIGS. 18 and 22), and transmits this to the controller 31. It should be noted that, in the present embodiment, illustration of the marker M such as that shown in FIG. 2 (B) shall be omitted (by the sensor unit 33 recognizing the marker M, the position of the locking part 21 of the electric vehicle 2 is detected and transmitted to the controller 31).

The arrangement 34 places the battery main body BH thereon and executes a rising and descending operation of the arrangement 34 itself, during attachment/detachment of this battery main body BH to the electric vehicle 2, based on the control of the controller 31.

The lock/release execution part 35 executes locking to the locking part 21 and releasing thereof, based on the control of the controller 31. In addition, the lock/release execution part 35 also executes an operation of slide movement of the battery main body BH. The lock/release execution part 35 of the present embodiment executes tightening of a bolt BT with a screw driver SD provided to the lock/release execution part 35, in the case of executing locking to a nut-shaped locking part 21, for example. On the other hand, the lock/release execution part 35 executes loosening of the bolt BT with the screw driver SD, in the case of executing the release of the locked state in which the bolt BT is tightened to the locking part 21. The lock/release execution part 35 of the present embodiment can realize quick release.

The lock/release execution part 35 is controlled with the controller 31 so as to operate in the left/right direction of FIG. 17 to cause the battery main body BH to slidingly move. The present embodiment is configured so that, according to the operation in the left/right direction of the lock/release execution part 35, the battery main body BH slidingly moves in the left/right direction subordinately.

The lock/release execution part 35 is formed in a substantially square column shape extending in the up/down direction such that inserts into a hole BHc described later of the battery main body BH. The screw driver SD is provided to a tip end of such a lock/release execution part 35.

The roller 36 is a substantially cylindrical shape having a rotation axis, and a plurality thereof are arranged so as to be aligned in the right/left direction in order to facilitate sliding movement of the battery main body BH.

Next, a battery frame BF constituting the battery module 202 in FIG. 16 will be described by referencing FIG. 18. FIG. 18 is a perspective view showing an example of a battery frame constituting the battery module in FIG. 16.

The battery frame BF includes a frame upper part BFa arranged so as to fit to the lower part 201 of the body of the electric vehicle 2, and a frame central part BFb which continues to this frame upper part BFa. The battery frame BF is arranged to the lower part 201 of the body of the electric vehicle 2 so that the longitudinal direction thereof matches the overall length direction of the electric vehicle 2, and the short direction matches the width direction of the electric vehicle 2.

The locking part 21, and a pair of battery guide-receivers BFd are provided to the frame upper part BFa. In addition, a frame-side connector BFc, frame-side receiver BFe and wiring section BFf (refer to FIG. 22) are provided to the frame central part BFb.

The locking part 21 provided to the frame upper part BFa has a nut-shaped portion which can tighten with the bolt BT. The pair of battery guide-receivers BFd have a guide function of guiding the battery main body BH to the appropriate connection position during mounting of the battery main body BH. In addition, the pair of battery guide-receivers BFd also have a function as receiving portions that regulate movement of the battery main body BH to the direction of gravity (for example, downwards). In other words, the pair of battery guide-receivers BFd has a function of centering for connector connection and receiving the battery main body BH.

The pair of battery guide receivers BFd are formed in a shape such that makes a substantially “V-shaped” in a plan view. In addition, the pair of battery guide-receivers BFd each have a guide wall which is vertical relative to the frame upper part BFa, and a receiver wall which continues to the end of this guide wall and is parallel to the frame upper part BFa, and overall is formed in a shape such that makes a substantially “V-shaped” in a plan view as described above and an “L-shaped” in cross-section.

The above such locking part 21 and pair of battery guide-receivers BFd are provided at four locations relative to the frame upper part BFa.

The frame-side connector BFc provided to the frame central part BFb is formed in an electrical connection portion with a battery-side connector BHb described later of the battery main body BH. It should be noted that, although not particularly illustrated, the frame-side connector BFc and battery-side connector BHb are each configured to include a connector housing and a plurality of terminals. The frame-side receiver BFe has a function as a receiver portion that regulates movement in the direction of gravity (for example, downward) of the battery main body BH.

The wiring section BFf is arranged inside of the frame central part BFb. It should be noted that FIG. 22 in which the wiring section BFf is shown is a cross-sectional view showing an example of an aspect immediately before completing mounting of the battery main body to the battery frame in FIG. 16. The wiring section BFf, although not particularly illustrated, is a portion compiling the wiring, etc. of the bus bar and various sensors (current sensor, voltage sensor, temperature sensor, etc.), and is connected to a junction block (electrical connection box) and control unit provided externally to the battery module 202, for example.

Next, a battery main body BH constituting the battery module 202 in FIG. 16 will be described referencing FIG. 19. FIG. 19 is a perspective view showing an example of a battery main body constituting the battery module in FIG. 16.

The battery main body BH is made by accommodating a plurality of cells within a housing, and outside of the housing, a guided-receiving part BHa which is guided to the appropriate connection position with a guide by the pair of battery guide-receivers BFd of the frame upper part BFa, and is received so that movement of the battery main body BH is restricted to the direction of its own weight. In addition, the battery-side connector BHb, which is the electrical connection portion of the frame upper part BFa with the frame-side connector BFc is also provided to the housing exterior of the battery main body BH.

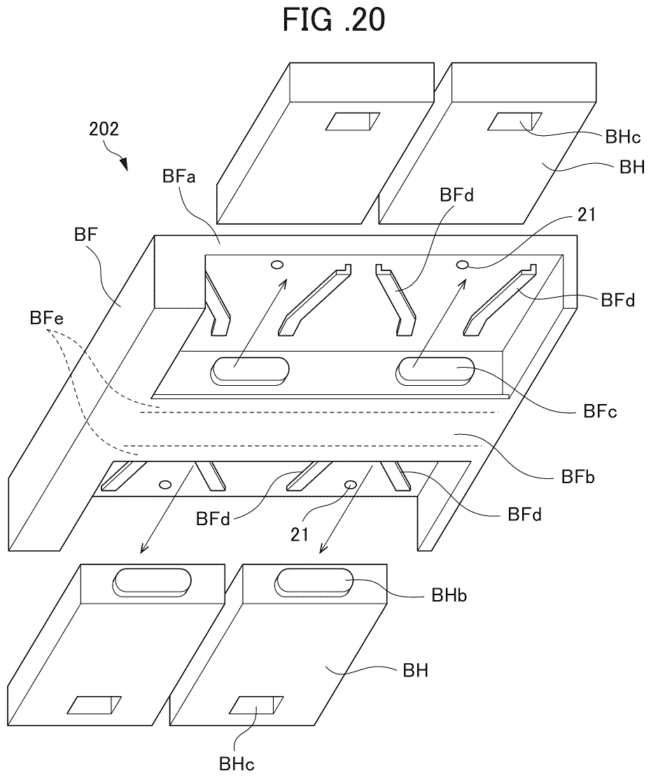

Holes BHc such as those shown in FIG. 20 to FIG. 22 are provided in the housing of the battery main body BH. This hole BHc is formed in a shape such that the substantially square-column shaped lock/release execution part 35 fits thereinto.

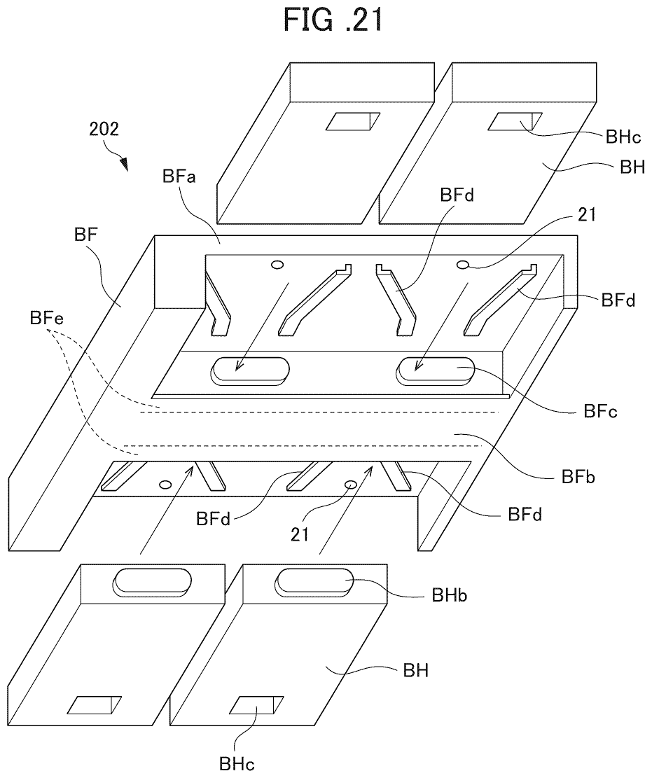

Such a battery main body BH is removed in a state such as that shown in FIG. 20 for replacement and is attached in a state such as that shown in FIG. 21. FIG. 20 is a perspective view showing an example of an aspect of removing a battery main body from the battery frame in FIG. 16. In addition, FIG. 21 is a perspective view showing an example of an aspect of mounting the battery main body to the battery frame in FIG. 16.

In FIG. 21, after the lock/release execution part 35 is inserted into the hole BHc of the battery main body BH, and the screw driver SD loosens the bolt BT, when the release operation of the lock/release execution part 35 is executed according to the control of the controller 31, four of the old battery main bodies BH respectively move in the directions indicated by the arrows in the drawings, whereby removal of the old battery main bodies BH completes (it is also acceptable to remove and replace only old battery main bodies BH without removing all four).

After removal of the old battery main bodies BH, if the conveyance robot 3 moves and four new battery main bodies BH are arranged according to the position of the battery frame BF, by the lock/release execution part 35 slidingly moving thereafter, four new battery main bodies BH move in the directions indicated by the arrows in FIG. 22. It should be noted that, at this time, even if arrangement of the battery main body BH is slightly shifted, it will be guided (centered) to the appropriate position by way of the above-mentioned guide function.

When connection of the connectors is made as shown in FIG. 22, and the screw driver SD tightens the bolt BT to the locking part 21, mounting of four new battery main bodies BH (replacement) completes. As is evident from FIG. 16 to FIG. 22, it is possible to impart variation to the attachment/detachment of batteries.

In addition, the hardware configuration shown in FIG. 5 is merely an exemplification for achieving the object of the present invention and is not particularly limited thereto.

In addition, the function block diagram shown in FIG. 6 is merely an exemplification and is not particularly limited thereto. In other words, it is sufficient if the function enabling the aforementioned series of processing (processing of flowchart shown in FIG. 7) to be executed as a whole is provided to the information processing system, and what kind of functional block is used for realizing this function is not particularly limited to the example of FIG. 6.

In addition, the location of existence of the functional blocks is not limited to FIG. 6, and may be arbitrary. For example, at least part of the functional blocks on the control device 4 side may be provided to the conveyance robot 3 shown in FIG. 4, or to another device which is not shown, or vice versa. Then, one functional block may be configured by a single piece of hardware or may be configured by combination with a single piece of software.

In the case of executing the processing of each functional block by way of software, the programs constituting this software are installed from a network or recording medium to a computer or the like. The computer may be a computer built into dedicated hardware. Further, the computer may be a computer capable of executing various functions by installing various programs, for example, a server, a general-purpose smartphone, or a personal computer.

The recording medium including such programs is constituted not only by a removable medium distributed separately from the apparatus main body in order to provide the program to the user or the like but also constituted by a recording medium or the like provided to the user or the like in a state of being incorporated in the apparatus main body in advance.

Note that, in the present specification, the steps writing the program recorded in the recording medium include not only the processing performed in time series along the order, but also the processing performed in parallel or individually without being necessarily performed in time series. In addition, in the present specification, the term “system” indicates an overall apparatus including a plurality of apparatuses, a plurality of means, and the like.

To summarize the above, the battery replacement system to which the present invention is applied only needs to have the following configuration and can adopt various embodiments. In other words, it is sufficient if the battery replacement system to which the present invention is applied is
a battery replacement system for replacing a battery (for example, the old battery B in FIG. 1) mounted in a state locked by a locking part (for example, the locking part 21 in FIG. 2B) at a lower part of a body of an electric vehicle (for example, the electric vehicle 2 in FIG. 1 or 2), the battery replacement system including:
a mobile body (for example, the conveyance robot 3 in FIG. 1 or FIG. 3) that conveys the battery as a replacement target; and
a control device (for example, the control device 4 in FIG. 1 or FIG. 4) that executes control of movement of the mobile body,
wherein the mobile body includes:
a drive unit (for example, the drive unit 32 in FIG. 3) that drives based on control by the control device;
a detection unit (for example, the sensor units 33O, 33N in FIG. 3) that detects a position of the locking part and transmits the position to the control device;
an arrangement (for example, the arrangements 34O, 34N in FIG. 3) that arranges the battery; and
a lock/release execution part (for example, the lock/release execution parts 35O, 35N in FIG. 3) that executes locking to the locking part or releasing thereof based on control by the control device, and
wherein the control device includes:
a first movement means (for example, the robot first movement unit 51 in FIG. 6) that drives the drive unit to cause the mobile body to move below the lower surface of the body of the electric vehicle (for example, move as in FIG. 10), on condition of the mobile body becoming mobile below the lower surface of the body of the electric vehicle (for example, condition of the electric vehicle 2 being placed on the slopes SL as shown in FIG. 9);
a second movement means (for example, the robot second movement unit 52 in FIG. 6) that drives the drive unit to cause the mobile body to move to a position of the locking part (for example, move to the position in FIG. 11), based on a detection result of the detection unit;
a battery removal means (for example, the battery removal unit 53 in FIG. 6) that causes the locking part to release by way of the lock/release execution part, removes the battery (for example, the old battery BO in FIG. 1 or 11) from the electric vehicle, and arranges on the arrangement (for example, refer to FIG. 11);
a third movement means (for example, the robot third movement unit 54 in FIG. 6) that drives the drive unit in a state in which a new battery for replacement (for example, the new battery BN in FIG. 1 or FIG. 12) is arranged on the arrangement, and causes the mobile body to move to a position of the locking part (for example, causes to move to the position in FIG. 12) based on a detection result of the detection unit; and
a battery mounting means (for example, the battery mounting unit 55 in FIG. 6) that mounts the new battery to a lower part of the body of the electric vehicle and causes the locking part to lock by way of the lock/release execution part (for example, refer to FIG. 12).

By configuring in this way, since it is sufficient to prepare only a mobile body and the control device thereof, it becomes possible to inexpensively and simply configurate a battery replacement system. Furthermore, by simply preparing a general-purpose self-propelled mini conveyance robot (the controller, etc. being existing technology), and attaching a detection unit (general-purpose sensor) and general-purpose lock/release execution part, it is possible to inexpensively and simply manufacture the mobile body. In addition, by simply producing the first movement means to battery mounting means with inexpensive and simple software, the control device can also be manufactured. By configuring in this way, it becomes possible to still more inexpensively and simply configure the battery replacement system. In addition, so long as being a location at which the mobile body can move below the lower surface of the body of the electric vehicle, since a large scale facility such as that conventionally is unnecessary, it becomes possible to realize a battery replacement system at a desired location such as a depopulated area, for example.

In addition, the first movement means can cause the mobile body to move below the lower surface of the body of the electric vehicle, on condition of the electric vehicle moving, and being placed on slopes installed in advance (for example, the slopes SL in FIG. 1 or FIG. 7).

So long as being a location at which slopes can be installed, no matter where, it is possible to adopt the battery replacement system, even without being a location having a conventional large-scale stationary-type facility.

In addition, at least one marker (for example, the marker M in FIG. 2B) is provided to the locking part or a position in the vicinity thereof, on the lower surface of the body of the electric vehicle. The detection unit can detect the positions of the plurality of markers as the positions of the locking part and transmit the position to the control device.

Since it is thereby possible to adopt a general-purpose sensor detecting the markers as the detection unit, it becomes possible to more inexpensively and simply configure the battery replacement system.

Each of the plurality of markers is provided at positions from which the size of the battery is recognizable. The control device can further include a battery size recognition means for recognizing the size of the battery based on the detection results of the detection unit.

In other words, the size of the battery varies according to the type of electric vehicle. Therefore, so long as being able to recognize the size of the battery before replacement thereof, it will be possible to immediately prepare the appropriate battery as the new battery. As a result, replacement of the battery can be done more efficiently.

Two of the mobile bodies are provided, and
the control device can
establish a first one of the mobile bodies as a control target for the first movement means, the second movement means and the battery removal means, and
establish a second one of the mobile bodies as a control target for the third movement means and the battery mounting means.

The battery removal means and the battery mounting means can perform sliding movement of the battery (for example, arrows indicating movement of battery main bodies BH in FIG. 20 and FIG. 21), by causing the lock/release execution part (for example, lock/release execution part 35 in FIG. 17) to slidingly move along the lower surface (for example, operation in left/right direction of FIG. 17), upon the removal and the mounting of the battery (for example, the battery main bodies BH in FIG. 20 and FIG. 21).

By preparing the mobile body (first) for battery removal and the mobile body (second) for new battery mounting, the battery replacement comes to be efficiently carried out.

### EXPLANATION OF REFERENCE NUMERALS

1 battery replacement system
2 electric vehicle
3 conveyance robot
4 control device
5 battery charging location
11 CPU
12 ROM
13 RAM
14 bus
15 I/O interface
16 input unit
17 output unit
18 storage unit
19 communication unit
20 drive
21 removable medium
31 controller
32 drive unit
33, 33O, 33L sensor unit
34, 34O, 34N arrangement
35, 35O, 35N lock/release execution part
51 robot first movement unit
52 robot second movement unit
53 battery removal unit
54 robot third movement unit
55 battery mounting unit
56 robot fourth movement unit
B battery
BO old battery
BN new battery
M marker
SL slope

1. A battery replacement system for replacing a battery mounted in a state locked by a locking part at a lower part of a body of an electric vehicle, the battery replacement system comprising:
a mobile body that conveys the battery as a replacement target; and
a control device that executes control of movement of the mobile body,
wherein the mobile body includes:
a drive unit that drives based on control by the control device;
a detection unit that detects a position of the locking part and transmits the position to the control device;
an arrangement that arranges the battery; and
a lock/release execution part that executes locking to the locking part or releasing thereof based on control by the control device, and
wherein the control device includes:
a first movement means that drives the drive unit to cause the mobile body to move below the lower surface of the body of the electric vehicle, on condition of the mobile body becoming mobile below the lower surface of the body of the electric vehicle;
a second movement means that drives the drive unit to cause the mobile body to move to a position of the locking part, based on a detection result of the detection unit;
a battery removal means that causes the locking part to release by way of the lock/release execution part, removes the battery from the electric vehicle, and arranges on the arrangement;
a third movement means that drives the drive unit in a state in which a new battery for replacement is arranged on the arrangement, and causes the mobile body to move to a position of the locking part based on a detection result of the detection unit; and
a battery mounting means that mounts the new battery to a lower part of the body of the electric vehicle, and causes the locking part to lock by way of the lock/release execution part.

2. The battery replacement system according to claim 1, wherein the first movement means causes the mobile body to move below a lower surface of the body of the electric vehicle, on condition of the electric vehicle moving to be placed on a slope installed in advance.

3. The battery replacement system according to claim 1, wherein one or more of a marker is provided to the locking part or a position in a vicinity thereof, on a lower surface of the body of the electric vehicle, and
wherein the detection unit detects a position of each of a plurality of the markers as positions of the locking part, and transmits the position to the control device.

4. The battery replacement system according to claim 3, wherein each of the plurality of markers is provided to a position from which a size of the battery is recognizable, and
wherein the control device further includes a battery size recognition means that recognizes a size of the battery based on a detection result of the detection unit.

5. The battery replacement system according to claim 1, wherein two of the mobile bodies are provided, and
wherein the control device
establishes a first one of the mobile bodies as a control target for the first movement means, the second movement means and the battery removal means, and
establishes a second one of the mobile bodies as a control target for the third movement means and the battery mounting means.

6. The battery replacement system according to claim 1, wherein the battery removal means and the battery mounting means perform sliding movement of the battery by causing the lock/release execution part to slidingly move along the lower surface, upon the removal and the mounting of the battery.

7. A battery replacement method executed by a control device in a battery replacement system for replacing a battery mounted in a state locked by a locking part at a lower part of a body of an electric vehicle, the battery replacement system comprising:
a mobile body that conveys the battery as a replacement target; and
the control device that executes control of movement of the mobile body,
wherein the mobile body includes:
a drive unit that drives based on control by the control device;
a detection unit that detects a position of the locking part and transmits the position to the control device;
an arrangement that arranges the battery; and
a lock/release execution part that executes locking to the locking part or releasing thereof based on control by the control device, and
the battery replacement method comprising:
a first movement step of driving the drive unit to cause the mobile body to move below the lower surface of the body of the electric vehicle, on condition of the mobile body becoming mobile below the lower surface of the body of the electric vehicle;
a second movement step of driving the drive unit to cause the mobile body to move to a position of the locking part, based on a detection result of the detection unit;
a battery removal step of causing the locking part to release by way of the lock/release execution part, removing the battery from the electric vehicle, and arranging on the arrangement;
a third movement step of driving the drive unit in a state in which a new battery for replacement is arranged on the arrangement, and causing the mobile body to move to a position of the locking part based on a detection result of the detection unit; and
a battery mounting step of mounting the new battery to a lower part of the body of the electric vehicle, and causing the locking part to lock by way of the lock/release execution part.

8. A non-transitory computer readable medium storing a program for executing control processing in a computer that controls a control device in a battery replacement system for replacing a battery mounted in a state locked by a locking part at a lower part of a body of an electric vehicle, the battery replacement system comprising:
a mobile body that conveys the battery as a replacement target; and
the control device that executes control of movement of the mobile body,
wherein the mobile body includes:
a drive unit that drives based on control by the control device;
a detection unit that detects a position of the locking part and transmits the position to the control device;
an arrangement that arranges the battery; and
a lock/release execution part that executes locking to the locking part or releasing thereof based on control by the control device, and
the control processing comprising:
a first movement step of driving the drive unit to cause the mobile body to move below the lower surface of the body of the electric vehicle, on condition of the mobile body becoming mobile below the lower surface of the body of the electric vehicle;
a second movement step of driving the drive unit to cause the mobile body to move to a position of the locking part, based on a detection result of the detection unit;
a battery removal step of causing the locking part to release by way of the lock/release execution part, removing the battery from the electric vehicle, and arranging on the arrangement;
a third movement step of driving the drive unit in a state in which a new battery for replacement is arranged on the arrangement, and causing the mobile body to move to a position of the locking part based on a detection result of the detection unit; and
a battery mounting step of mounting the new battery to a lower part of the body of the electric vehicle, and causing the locking part to lock by way of the lock/release execution part.
